(19) United States
(12) Patent Application Publication
(10) Pub. No.: US 2026/0008424 A1
(43) Pub. Date: Jan. 8, 2026

(54) MECHANISMS FOR CONNECTING STRUCTURES TO VEHICLES

(71) Applicant: SOUCY INTERNATIONAL INC., Drummondville (CA)

(72) Inventors: Jean-Michel GUY-LECLERC, Drummondville (CA); Nicolas AUBE, Drummondville (CA); Vincent MORIN, Saint-Hyacinthe (CA); Pascal GAUDET, Drummondville (CA); Pierre-Louis BARIL, Sainte-Cecile-de-Levrard (CA); Normand ROY, St-Hugues (CA); Gabriel BOISVERT, Beloeil (CA)

(21) Appl. No.: 19/262,955

(22) Filed: Jul. 8, 2025

Related U.S. Application Data
(60) Provisional application No. 63/668,593, filed on Jul. 8, 2024.
(60) Provisional application No. 63/686,981, filed on Aug. 26, 2024.

(51) Int. Cl. B60R 19/02

(52) U.S. Cl. CPC B60R 19/023; B60R 2019/026

(57) ABSTRACT

A mechanism includes a first component, a second component and a biasing assembly. The first component and a second component are configured to attach a structure to a vehicle. The biasing assembly, which includes a biasing member, operatively connects the first component and the second component to one another. When a force is applied along a first direction on the first component, the biasing member biases the first component against the second component in a rest position to transfer the force from the first component to the second component. When the force is applied along a second direction on the first component, the second direction being opposite to the first direction, the biasing member absorbs at least a portion of the force in a loaded position.

### CROSS-REFERENCE TO RELATED APPLICATIONS

This present application claims priority to U.S. Provisional Patent Application No. 63/668,593, filed Jul. 8, 2024 and U.S. Provisional Patent Application No. 63/686,981, filed Aug. 26, 2024, entitled “Mechanisms for Connecting Structures to Vehicles”, both of which are incorporated by reference herewith.

### TECHNICAL FIELD

The present technology generally relates to vehicles, structures and mechanisms for connecting structures to vehicles.

### BACKGROUND

All-Terrain Vehicles (ATVs) are widely used for a variety of purposes, including recreational activities, agricultural tasks, and industrial applications. Such vehicles are often equipped with structures designed to enhance functionality and safety. Due to their versatile nature, ATVs often traverse rough and unpredictable terrains, which can expose them to a high risk of collision with obstacles such as rocks, trees, and/or other vehicles. To mitigate the damage resulting from such collisions, it is common practice to equip ATVs with bumpers.

Bumpers can provide protection to the vehicle and/or to the operator thereof by absorbing shocks and impacts during the operation of the vehicle. This type of structure is typically mounted at front and/or rear end(s) of the vehicle and are designed to absorb and dissipate the energy from impacts, thereby protecting both the vehicle and/or the operator thereof. Traditional “cage bumpers” may be made from materials such as steel and/or aluminium. However, different materials and designs may be used depending on inter alia the specific requirements of the vehicle and its intended use. In some cases, bumpers can provide support for accessories mounted thereon for adding functionalities to the vehicle.

While conventional bumpers serve their purpose of shock absorption, there remains a need for improved bumper designs, as well as other components and/or accessories that provide enhanced protection, durability, and functionality. Innovations in materials, structural design, mounting systems, and integration with other vehicle systems can offer better performance, reduce the risk of damage, and extend the service life of the vehicle.

### SUMMARY

The present technology aims at addressing at least some drawbacks of prior art solutions for connecting structures to vehicles.

In one aspect of the present technology, there is provided a mounting system for connecting a structure to a body of a vehicle. The mounting system comprises one or more mechanisms that operatively connect the structure to the body of the vehicle. A mechanism of the mounting system is configured to operate as a “biasing connection” or joint between the structure and the body of the vehicle when a force is applied along a first direction, and as a “rigid connection” or joint between the structure and the body of the vehicle when a force is applied along a second, opposite direction. When the force is applied along the first direction, the mechanism is configured to absorb at least a portion of the force. When the force is applied along the second, opposite direction, the mechanism is configured to transfer the force to the body of the vehicle.

In one aspect of the present technology, the mechanism comprises a first component operatively connected to a second component by a biasing assembly. The biasing assembly comprises a biasing member configured to bias the first component against the second component in a resting position of the mechanism. When a force is applied on the first component along a first direction, the mechanism moves to a loaded position in which the biasing member deforms and absorbs at a least a portion of the force. When the force is applied on the first component along a second opposite direction, the mechanism remains in the rest position and the force is transferred from the first component to the second component.

According to one aspect of the present technology, there is provided an impact-absorbing mechanism configured to connect a structure to a vehicle. The impact-absorbing mechanism includes a first component, a second component, and a biasing assembly. The biasing assembly operatively connects the first component and the second component to one another, and includes a biasing member. When a force is applied along a first direction on the first component, the biasing member biases the first component against the second component in a rest position to transfer the force from the first component to the second component. When the force is applied along a second direction on the first component, the second direction being opposite to the first direction, the biasing member deforms and absorbs at least a portion of the force in a loaded position.

In some embodiments, the biasing assembly further includes a housing and a connection assembly. The housing defines an elongated cavity extending along an axis of the biasing assembly. The first direction and the second direction are two opposite directions along the axis. The biasing member is received in the elongated cavity. The connection assembly is configured to transfer the force between the first component and the second component. The connection assembly is received in the elongated cavity. When the force is applied along the first direction on the first component, the biasing member biases the connection assembly against the housing in the rest position to transfer the force from the first component to the second component. When the force is applied along the second direction, the connection assembly transfers the force to the biasing member to deform and absorb at least the portion of the force in the loaded position.

In some embodiments, when the force is applied in the first direction, the mechanism is under a tensile load, and when the force is applied in the second direction, the mechanism is under a compressive load.

In some embodiments, with the biasing member in the rest position, the mechanism operates as a rigid joint, and with the biasing member in the loaded position, the mechanism operates as a resilient joint.

In some embodiments, the axis is a first axis, and the connection assembly is a pivoting connection assembly configured to pivot about one of the first axis and a second axis angled relative to the first axis.

In some embodiments, the biasing member is a resilient member made from a resilient material.

In some embodiments, the resilient material is an elastomeric material.

In some embodiments, the resilient material is a plurality of resilient materials, each resilient material of the plurality of resilient material having a given rigidity for providing a composite shock absorption profile.

In some embodiments, the biasing member is at least one of a spring member, a pneumatic member, and a hydraulic member.

In some embodiments, the biasing member is a frangible biasing member configured to break in response to force applied along the second direction being greater than a pre-determined magnitude.

In some embodiments, the biasing member is selectively removable from the biasing assembly for replacement.

In some embodiments, the first and second components move relatively to each along a translational movement or a pivotal movement.

In some embodiments, at least one of the first and second components is an integral component of at least one of the structure and the vehicle.

In some embodiments, the structure is a bumper.

In some embodiments, the bumper is a rigid bumper.

In some embodiments, the bumper is a flexible bumper comprising a first sub-structure and a second sub-structure, and an other mechanism. The mechanism is for attaching the first sub-structure to the vehicle, and the second mechanism is for attaching the first sub-structure to the second sub-structure.

In some embodiments, the structure is at least one of: a rock slider, a push frame, a tail tongue, and a fender protector.

According to another aspect of the present technology, there is provided first and second mechanisms according to the above aspect or according to the above aspect and one or more of the above embodiments, the first mechanism and the second mechanism being connected in one of: series or parallel for forming a composite shock absorption profile.

According to another aspect of the present technology, there is provided a mounting system for mounting the structure to the vehicle. The mounting structure includes one or more impact-absorbing mechanisms according to the above aspect and one or more of the above embodiments.

According to another aspect of the present technology, there is provided a structure connectable to the vehicle using the mounting system of the above aspect.

According to another aspect of the present technology, there is provided structure connectable to another structure selectively fixedly connected to the vehicle using the mounting system of the above aspect.

According to another aspect of the present technology, there is provided a vehicle connected to the structure of the above aspect.

Developers of the present technology have realized that a mechanism that selectively operates as a biasing connection or a rigid connection between the structure and the body of the vehicle depending on the direction of the force applied on the structure may enable additional functionalities for the structure. Different types of structures are contemplated, such as bumpers, rock sliders, push frames, tail tongues, and fender protectors, for example.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front a vehicle having a front bumper in accordance with at least some non-limiting embodiments of the present technology;

FIG. 2 is a perspective view taken from a front, top, left side of the front bumper of FIG. 1 and a mounting system;

FIG. 3A is an exploded perspective view of a mechanism of the mounting system of FIG. 2 for selectively connecting the front bumper to the vehicle, in accordance with at least some non-limiting embodiments of the present technology;

FIG. 3B is perspective view of the mechanism of FIG. 3A in an assembled configuration;

FIG. 3C is a close-up perspective view of the mechanism of FIG. 3A in the assembled configuration;

FIG. 4A is a schematic illustration of the mechanism of FIG. 3A in a rest position with no external forces being applied thereto;

FIG. 4B is a schematic illustration of the mechanism of FIG. 3A in the rest position with an external force being applied on the mechanism along a first direction;

FIG. 4C is a schematic illustration of the mechanism of FIG. 3A in a loaded position with an external force being applied on the mechanism along a second direction, opposite to the first direction;

FIG. 4D is a schematic illustration of a mechanism of the mounting system of FIG. 2, in accordance with at least some non-limiting embodiments of the present technology, the mechanism being in a rest position with no external forces being applied thereto;

FIG. 4E is a schematic illustration of two mechanisms of FIG. 3A connected in series;

FIG. 4F is a schematic illustration of two mechanisms of FIG. 3B connected in parallel;

FIG. 5A is a perspective view of a front bumper in accordance with one embodiment of the present technology;

FIG. 5B is an other perspective view of the front bumper of FIG. 5A;

FIG. 6A is a perspective view of a front bumper in accordance with an other embodiment of the present technology;

FIG. 6B is an other perspective view of the front bumper of FIG. 6B; and

FIGS. 7A to 7D are illustrations of a rock slider, a push frame, a tail tongue, and a fender protector, mounted to respective vehicles, in accordance with at least some non-limiting embodiments of the present technology.

### DETAILED DESCRIPTION

It is to be expressly understood that the various embodiments of mechanisms, mounting systems, structures and vehicles are merely embodiments of the present technology. Thus, the description thereof that follows is intended to be only a description of illustrative examples of the present technology. This description is not intended to define the scope or set forth the bounds of the present technology. In some cases, what are believed to be helpful examples of modifications or alternatives to apparatus may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing or embodying that element of the present technology. As a person skilled in the art would understand, this is likely not the case. In addition, it is to be understood that the apparatus may provide in certain aspects a simple embodiment of the present technology, and that where such is the case it has been presented in this manner as an aid to understanding. As persons skilled in the art would understand, various embodiments of the present technology may be of a greater complexity than what is described herein.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a structure and components in relation to the structure, such as “vertical”, “horizontal”, “forwardly”, “rearwardly”, “left”, “right”, “above” and “below”, are as they would be understood by a driver of a vehicle to which the structure is connected sitting thereon in an upright driving position, with the vehicle steered straight-ahead and being at rest on flat, level ground.

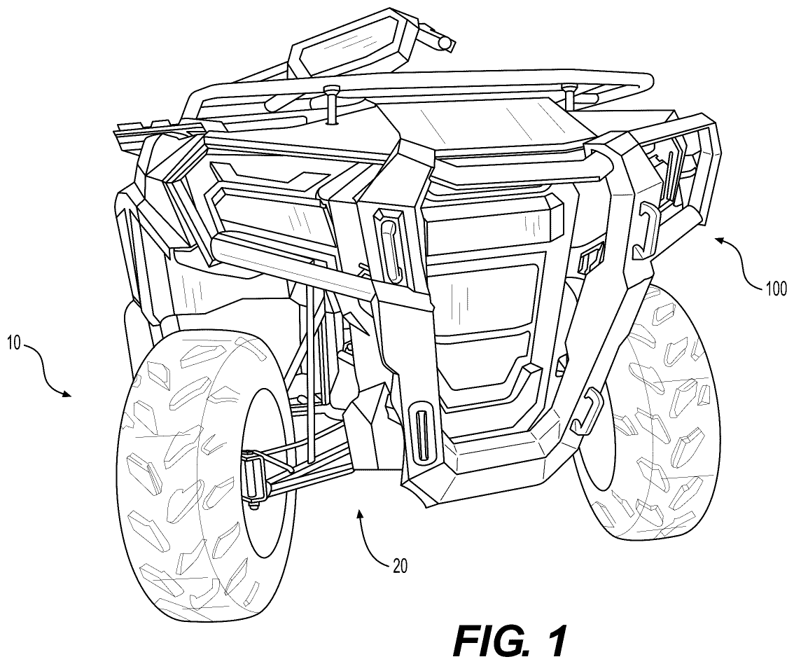

With reference to FIG. 1, there is depicted a front bumper 100 mounted to a vehicle 10 in accordance with the principles of the present technology. Though the vehicle 10 is shown as an all-terrain vehicle (ATV), other types of vehicles such as snowmobiles and motorcycles are contemplated. The mounting system 20 in accordance with the principles of the present technology is particularly, but not necessarily, adapted for use on recreational vehicles. Such vehicles often are straddle-type vehicles. The mounting system 20 can be used on other types of vehicles as well as, but without being limited to, agricultural, military, industrial, and exploratory vehicles.

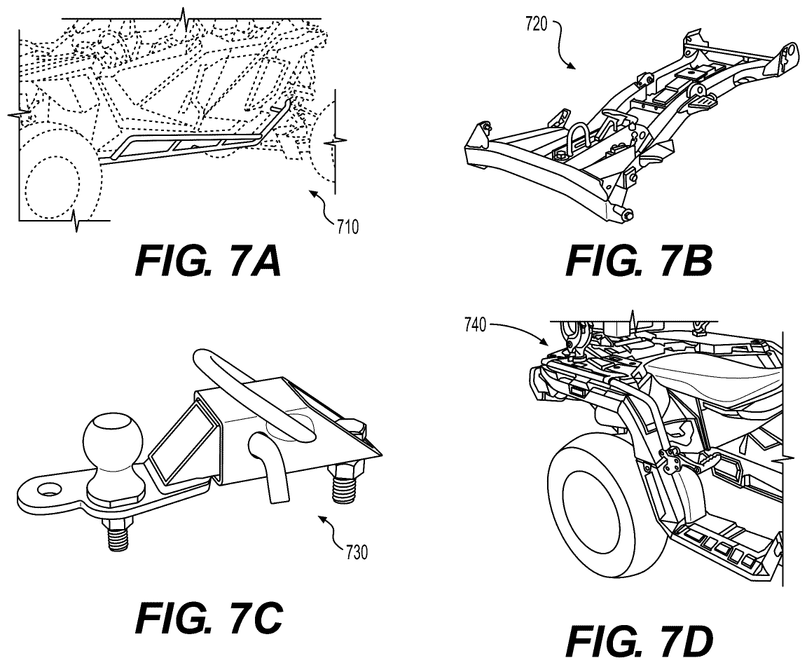

Also, though the front bumper 100 shown in FIG. 1 is a bumper, the mounting system 20 may be configured to connect a variety of structures, components and/or accessories to the vehicle 10, as it will be described in greater details herein further below with reference to FIGS. 7A to 7D.

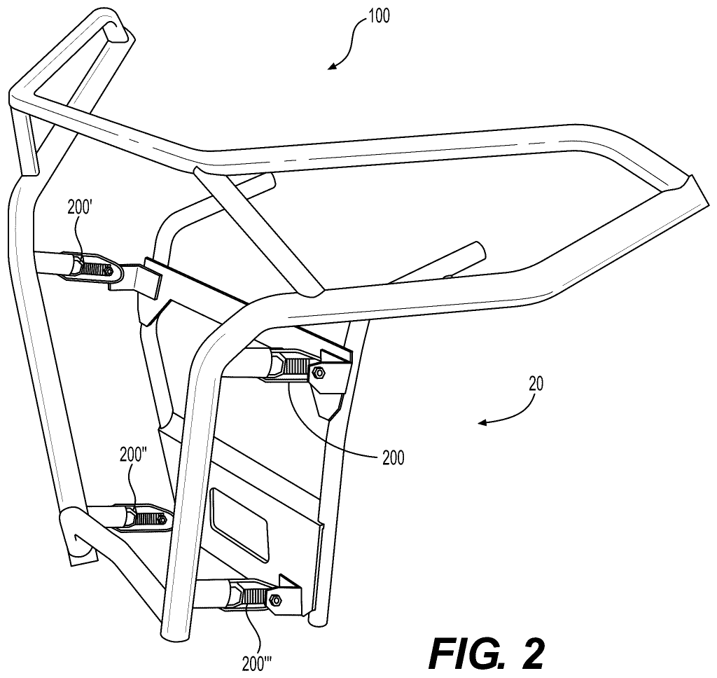

With reference to FIG. 2, there is depicted the bumper 100 with the mounting system 20 comprising impact-absorbing mechanisms 200, 200′, 200″, and 200″″ (simply referred to as mechanism) which are configured to connect the bumper 100 to a body of the vehicle 10.

In this non-limiting example, the mounting system 20 comprises four mechanisms for connecting the bumper 100 to the body of the vehicle 10. However, this might not be the case in each and every embodiment of the present technology. For example, a given component and/or accessory of the vehicle 10 may be connected to the body of the vehicle 10 via a single, two, three or five or more mechanisms implemented similarly to the mechanism 200.

In this non-limiting example, the mechanisms 200, 200′, 200″, and 200′″ are configured to operate as resilient joints that can absorb a portion of shocks suffered by the bumper 100 during impacts, thus reducing the shocks transmitted to the vehicle 10. Thus, the mechanisms 200, 200′, 200″, and 200′″ may be referred to as shock-absorbing mechanisms. In this non-limiting example, the mechanisms 200, 200′, 200″, and 200′″ are configured to operate as rigid joints when the bumper 100 is used as a structural element for pulling loads by the vehicle 10 for example, thus providing an additional functionality to the vehicle 10 and/or to the user. In this non-limiting example, the mechanisms 200, 200′, 200″, and 200′″ are configured to operate as rigid joints in tension and as resilient joints in compression for the bumper 100 of the vehicle 10. However, it is contemplated that in some cases, the mechanisms 200, 200′, 200″, and 200′″ may be configured to operate as rigid joints in compression and as resilient joints in tension for a structure, component and/or accessory to be mounted on the vehicle 10.

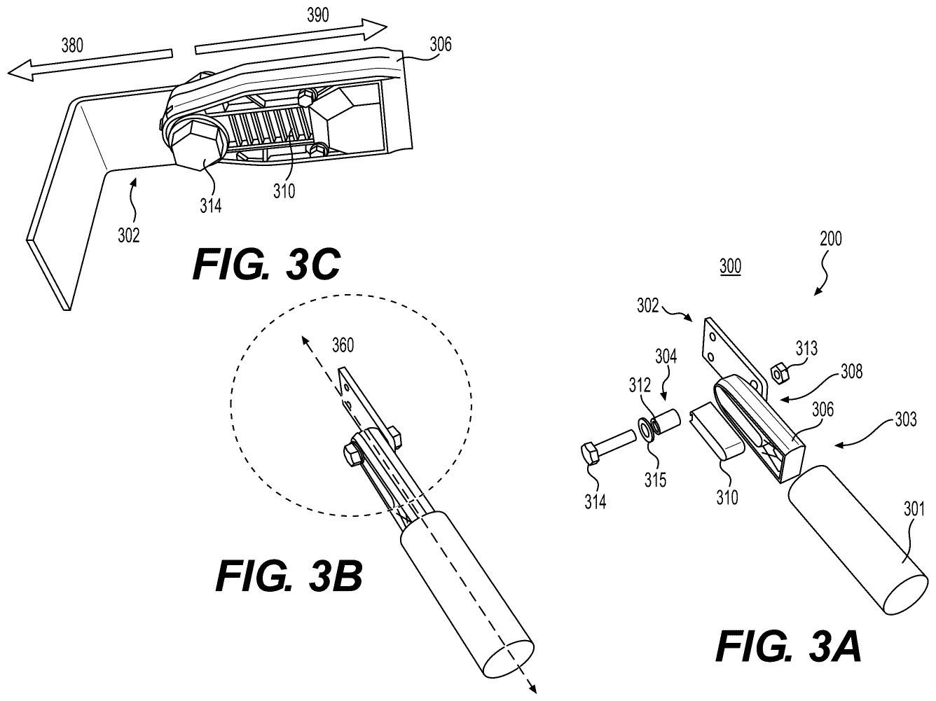

With reference to FIGS. 3A to 3C, there is depicted the mechanism 200 in an exploded configuration and in an assembled configuration. It should be noted that the mechanisms 200′, 200″, and 200′″ are similar to the mechanism 200, and may be implemented similarly thereto, such that the mechanisms 200′, 200″, and 200′″ will not be described in greater detail for the sake of brevity.

The mechanism 200 comprises a first component 301 and a second component 302. The first component 301 and the second component 302 are configured for attaching a given structure (such as the bumper 100) to a given vehicle (such as the vehicle 10). In this embodiment, the first component 301 is configured to be attached to the vehicle 10, while the second component 302 is configured to be attached to the bumper 100. It is contemplated that the first component 301 may be an integral portion of the vehicle 10 and/or that the second component may be an integral component of the bumper 100, without departing from the scope of the present technology.

The mechanism 200 also comprises a biasing assembly 303 operatively connecting the first component 301 and the second component 302 to one another. The biasing assembly 303 comprises a housing 306, a biasing member 310, and a connection assembly 304.

The housing 306 defines an elongated cavity 308 extending along an axis 360 of the biasing assembly 303. In this embodiment, the housing 306 is fixedly attached to the second component 302 while the connection assembly 304 is fixedly attached to the first component 301. However, it is contemplated that in some embodiments of the present technology, the housing 306 may be fixedly attached to the first component 301, while the connection assembly 304 may be fixedly attached to the second component 302.

The biasing member 310 is configured to be received in the elongated cavity 308. In some embodiments, the biasing member 310 can be made of a resilient material. In some embodiments, the resilient material is an elastomeric material. In some embodiments, the resilient material is polyurethane, elastomer, or rubber. In some embodiments, the biasing member 310 could be made of two or more material configured to obtain a desired composite shock absorption profile. The selection of resilient material may depend on, inter alia, a desired resiliency for the mechanism 200. However, it is contemplated that the biasing member 310 may be implemented via other biasing means such as but not limited to a spring member, a pneumatic member, and/or a hydraulic member. In further embodiments, the biasing member 310 may be implemented using a combination of materials and systems offering a biasing effect to return to an initial position and damping effect when compressed. It is contemplated that the biasing member 310 may be a frangible and/or a consumable biasing member configured to be replaced when the biasing member 310 absorbs a shock of a pre-determined magnitude.

In some cases, the biasing member 310 can be made of a material having a certain plasticity (i.e., with the ability to undergo permanent deformation) such that in response to being subjected to forces equal to or beyond a pre-determined magnitude, the biasing member 310 may undergo a non-reversible change of shape. In some other cases, the biasing member 310 can be shaped and configured so that a portion thereof irreversibly breaks in response to being subjected to a force equal to or beyond a pre-determined magnitude. In such cases, when the biasing member 310 is deformed in response to the application of a force equal to or beyond the pre-determined value, the deformed biasing member 310 can be replaced by a new biasing member 310 for optimal working conditions.

It is contemplated that biasing members having different rigidities can be provided for different shock absorption magnitudes. For example, some biasing members may be rated for “low capacity”, for “medium capacity”, or for “high capacity” based on their resiliency and their rigidity.

It is contemplated that in some embodiments, the biasing members may have to be changed periodically in accordance with a pre-determined schedule to ensure that their shock absorption properties meet a pre-determined specification.

The connection assembly 304 is configured to transfer forces between the first component 301 and the second component 302. To that end, at least a portion of the connection assembly 304 is received in the elongated cavity 308 of the housing 306.

In this embodiment, the connection assembly 304 comprises a fastener 314, a sleeve 312, a retainer 315, and a nut 313. The sleeve 312 is configured to accommodate the fastener 314 and is receivable in the elongated cavity 308. The fastener 314 is configured to cooperate with the nut 313 and the retainer 315 to retain the sleeve 312 in the elongated cavity 308. The fastener 314 is also configured to cooperate with the nut 313 and the retainer 315 to be selectively fixedly attached to the second component 302. The fastener 314 is also configured to cooperate with the nut 313 and the retainer 315 to selectively movably connect the second component 302 to the housing 306. In other words, the second component 302 may move relative to the housing 306 as the sleeve 312 moves along the elongated cavity 308.

Although in this embodiment, the connection assembly 304 is selectively fixedly attached to the second component 302, this may not be the case in each and every embodiment. In other embodiments, it is contemplated that the connection assembly 304 may be a pivoting connection assembly, which not only allows movement of the second component 302 relative to the housing 306 along the axis 360, but also allows a pivoting movement of the second component 302 about the axis 360 and/or about an other axis. As schematically illustrated in FIG. 3B, the other axis may be an axis 361 perpendicular to the axis 260. The other axis may be skewed relative to the axis 360 (i.e., angled relative thereto). Different configurations of a pivoting connection assembly are contemplated.

It can be said that a given connection assembly may serve as a “pivot” between the first component 301 and second component 302, so that a relative pivoting movement between the first component 301 and second component 302 is permissible via the pivot. However, the relative pivoting movement between the first component 301 and second component 302 may be prohibited via a non-pivoting connection assembly, so as to allow only a translational movement along the axis 360.

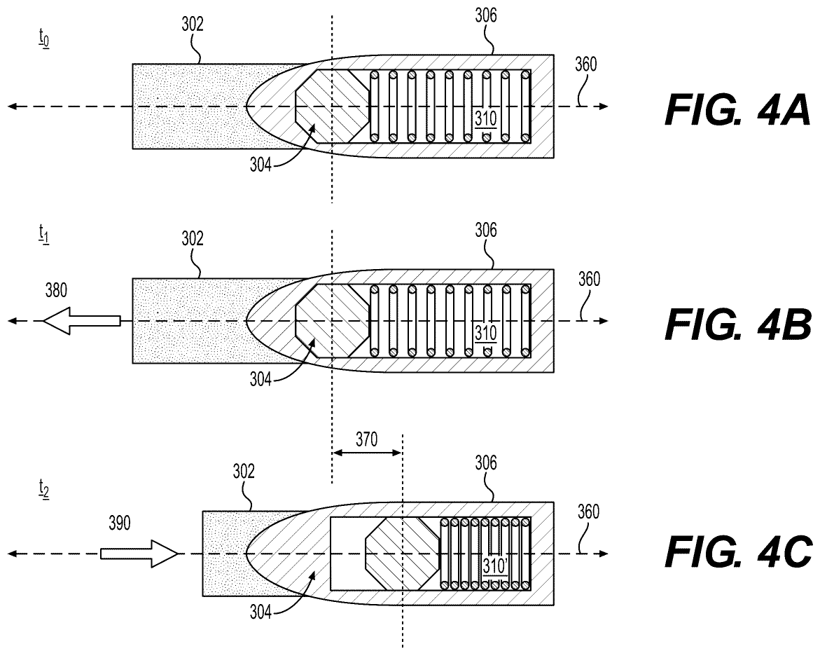

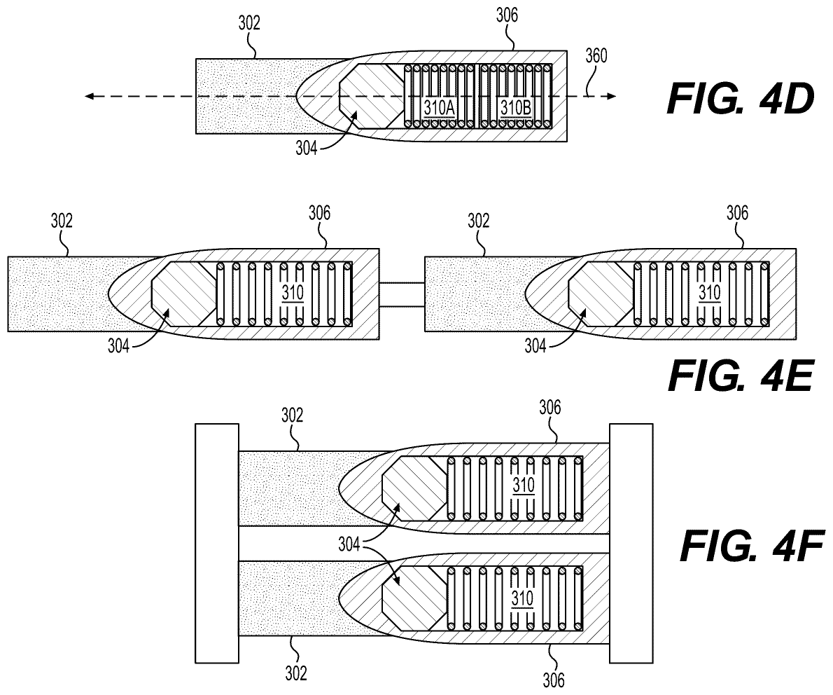

With reference to FIGS. 4A to 4C, there is depicted schematic illustrations of the mechanism 200 in respective configurations at different moments in time during operation of the mechanism 200. The respective configurations will now be described.

As seen in FIG. 4A, at time to, no external forces are applied on the second component 302. In this configuration, the biasing member 310 is configured to bias the connection assembly 304 against the housing 306. In this configuration, the mechanism 200 is in a rest position.

As seen in FIG. 4B, at time t₁, an external force 380 is applied onto the second component 302 along a first direction along the axis 360. In this example, the external force 380 applies a tensile load on the mechanism 200, such that the mechanism 200 is under tension. When the external force 380 is applied along the first direction on the second component, the biasing member 310 continues to bias the connection assembly 304 against the housing 306 so as to transfer the external force 380 from the second component 302 to the first component 301 via the housing 306. In this configuration, the mechanism 200 remains in the rest position.

As seen in FIG. 4C, at time t₂, an external force 390 is applied onto the second component 302 along a second direction along the axis 360. The second direction of the external force 390 is an opposite direction to the first direction of the external force 380. In this example, the external force 390 applies a compressive load on the mechanism 200, such that the mechanism 200 is under compression. When the external force 390 is applied along the second direction on the second component 302, the connection assembly 304 is configured to transfer the external force 390 to the first component 301 via the housing 306 and the biasing member 310. In response, the biasing member 310 is configured to deform and absorb a portion of the external force 390. When the biasing member 310 deforms and absorbs the portion of the external force 390, the biasing member 310 transitions to an at least partially compressed state 310′, while the connection assembly 304 moves along the elongated cavity 308. As a result, in this configuration the mechanism 200 moves from the rest position to a loaded position. The second component 302 moves relative to the first component 301 by a distance 370 when the mechanism 200 moves from the rest position to the loaded position.

When the mechanism 200 is in the loaded position, the biasing member 310 biases the connection assembly 304 toward its initial position (i.e., rest position). When the external force 390 is less than the biasing force provided by the biasing member 310, the connection assembly 304 moves toward its initial position.

Referring to FIG. 4D, which illustrates an other embodiment of the mechanism 200, it is contemplated that the mechanism 200 could be configured to have two different biasing members 310A, 310B received within the elongated cavity 308. In some embodiments, only one of the two biasing members 310A, 310B may need to be replaced in response to the applied force exceeding a threshold value. In other embodiments, using two biasing members could assist in providing a desired shock absorption profile.

Referring to FIGS. 4E and 4F, it is contemplated that two or more mechanisms 200 having a similar or different shock absorption properties may be used in series (FIG. 4E) or in parallel (FIG. 4F) to provide a desired shock absorption profile.

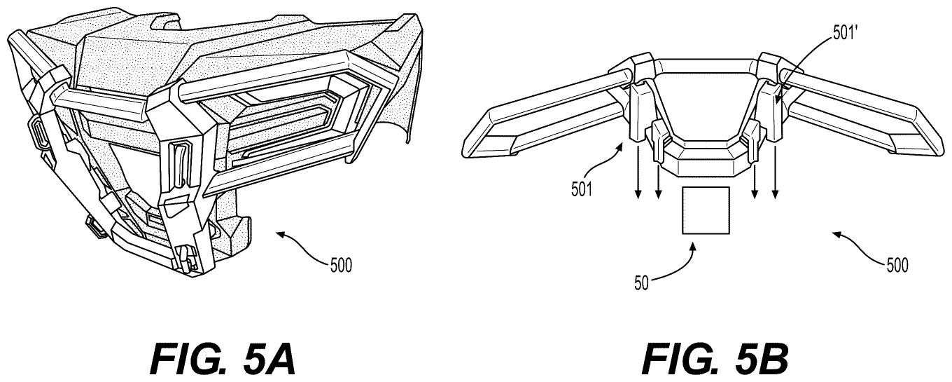

With reference to FIGS. 5A and 5B, there is depicted a monobloc bumper 500 that is selectively connected to a body of a given vehicle using the mounting system 50 comprising at least a mechanism 501 and a mechanism 501′. The mechanisms 501 and 501′ may be implemented similarly to the mechanism 200 described above.

In this embodiment, in response to an external force being applied on the monobloc bumper 500, and the external force being oriented towards the given vehicle body, the mechanisms 501 and 501′ provide a biasing connection between the monobloc bumper 500 and the given vehicle. The biasing connection provides a shock absorbing functionality for the monobloc bumper 500 and allows translational movement of the monobloc bumper 500 relative to the given vehicle.

In this embodiment, in response to an external force being applied on the monobloc bumper 500, and the external force being oriented away from the given vehicle body, the mechanisms 501 and 501′ provide a fixed connection between the monobloc bumper 500 and the given vehicle. The fixed connection provides a second functionality for the monobloc bumper 500 by preventing translational movement of the monobloc bumper 500 relative to the given vehicle. In one non-limiting example, the monobloc bumper 500 may function as a winching structure for the given vehicle without damaging the shock absorbing functionality of the monobloc bumper 500. In this embodiment, it is understood that the monobloc bumper 500 moves relative to the vehicle body to which it is connected via the mechanisms 501 and 501′ along at least one translational axis. In some cases, the monobloc bumper 500 may move relative to the vehicle body to which it is connected via the mechanisms 501 and 501′ along at least one pivotal axis as well.

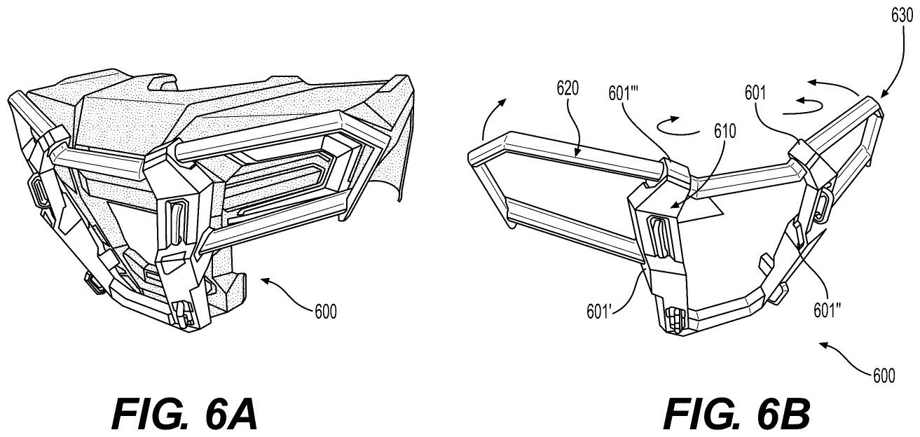

With reference to FIGS. 6A and 6B, there is depicted a flexible bumper 600 selectively connected to a given vehicle. The flexible bumper 600 comprises a central sub-structure 610 rigidly fixed to the given vehicle. The flexible bumper 600 also comprises side sub-structures 620 and 630 connected to the central sub-structure 610. The side sub-structures 620 and 630 are connected to the central sub-structure 610 via mechanisms 601, 601′, 601″, and 601′″. The mechanisms 601, 601′, 601″, and 601′″ may be implemented similarly to the mechanism 200 described above.

In this embodiment, the mechanisms 601, 601′, 601″, and 601′″ may provide a fixed connection between respective sub-structures in response to forces applied in a first direction, and a biasing connection between respective sub-structures in response to forces applied in a second opposite direction. In this embodiment, the mechanisms 601, 601′, 601″, and 601′″ comprise pivoting connection assemblies allowing for a pivoting motion between respective sub-structures, without departing from the scope of the present technology.

Although in this embodiment, the central sub-structure 610 is fixedly attached to the given vehicle, this might not be the case in each and every embodiment of the flexible bumper 600. In other embodiments, the flexible bumper 600 may be selectively attached to the given vehicle using the mounting system 50 (see FIGS. 5A and 5B), without departing from the scope of the present technology.

It should be noted that the front and rear bumpers of vehicles such as ATVs, side-by-side vehicles, and snowmobiles are protective components designed to absorb impacts and reduce damage to the vehicle and/or injuries to the user thereof during collisions or encounters with obstacles. Bumpers provide a first line of defense, safeguarding both the vehicle and its occupants. Mounting systems in accordance with the present technology can allow a dual-functionality connection which operates, depending on an external force applied thereto, as a biasing connection for shock absorption or a rigid connection for added structural support. However, other structures than bumpers may benefit from one or more mounting systems and/or one or more mechanisms described herein.

With reference to FIG. 7A, there is depicted a nerf bar 710, also known as a rock slider, connected to a respective vehicle. A nerf bar is a protective accessory mounted along the sides of off-road vehicles, such as ATVs, for example. Nerf bars serve to protect the vehicle's lower body and frame from damage caused by rocks, debris, and other obstacles encountered during off-road use. It is contemplated that the nerf bar 710 may be connected to the respective vehicle using mounting systems discloses herein. The nerf bar 710 may also comprise one or more mechanisms disclosed herein for connecting different sub-structures of the nerf bar 710, without departing from the scope of the present technology.

With reference to FIG. 7B, there is depicted a push frame 720 that allows various attachments, such as plows, buckets, and other accessories, to be securely connected to the front of a respective vehicle. The push frame 720 facilitates the attachment of equipment used for tasks such as snow removal, material handling, and landscaping. The push frame 720 may be connected to the respective vehicle using mounting systems discloses herein.

With reference to FIG. 7C, there is depicted a trailer tongue 730 that connects a trailer to a hitch of a respective vehicle. The trailer tongue 730 transmits the towing force and stabilizes the trailer during movement. The trailer tongue 730 may be connected to the respective vehicle using mounting systems discloses herein.

With reference to FIG. 7D, there is depicted a fender protector 740 designed to shield a respective vehicle's fenders from damage caused by debris, rocks, and other hazards encountered during driving, particularly in off-road conditions. The fender protector 740 may be connected to the respective vehicle using mounting systems discloses herein. The fender protector 740 may also comprise one or more mechanisms discloses herein for connecting different sub-structures of the fender protector 740, without departing from the scope of the present technology.

It is contemplated that non-limiting examples of structures connectable to vehicles described above may share a common function of providing protection to various parts of the vehicle. In many cases, these structures may benefit from the use of both biasing connection and rigid connection depending on external forces applied thereto. A biasing connection is desirable when shock absorption and/or flexibility is required to protect the vehicle from impacts and vibrations. Conversely, a rigid connection is useful when strength, stability, and/or precise control is desirable, such as during winching, for example. Enabling two different types of connections allows these structures to effectively perform their protective functions while enhancing the overall durability and performance of the vehicle.

It is contemplated that the mechanism described herein may be used to connect an accessory to a vehicle body and/or to a structure (e.g. bumper). This may assist in preventing damage to the accessory during an impact.

Modifications and improvements to the above-described embodiments of the present technology may become apparent to those skilled in the art. The above description is intended to be exemplary rather than limiting.

1. An impact-absorbing mechanism configured to connect a structure to a vehicle, comprising:
a first component and a second component;
a biasing assembly operatively connecting the first component and the second component to one another, the biasing assembly including a biasing member, and wherein:
in response to a force being applied along a first direction on the first component, the biasing member biases the first component against the second component in a rest position to transfer the force from the first component to the second component; and
in response to the force being applied along a second direction on the first component, the second direction being opposite to the first direction, the biasing member deforms and absorbs at least a portion of the force in a loaded position.

2. The impact-absorbing mechanism of claim 1, wherein the biasing assembly further comprises:
a housing defining an elongated cavity extending along an axis of the biasing assembly, the first direction and the second direction being two opposite directions along the axis, the biasing member being received in the elongated cavity; and
a connection assembly configured to transfer the force between the first component and the second component, the connection assembly being received in the elongated cavity; and wherein:
in response to the force being applied along the first direction on the first component, the biasing member biases the connection assembly against the housing in the rest position to transfer the force from the first component to the second component; and
in response to the force being applied along the second direction, the connection assembly transfers the force to the biasing member to deform and absorb at least the portion of the force in the loaded position.

3. The impact-absorbing mechanism of claim 1, wherein:
in response to the force being applied in the first direction, the impact-absorbing mechanism is under a tensile load; and
in response to the force being applied in the second direction, the impact-absorbing mechanism is under a compressive load.

4. The impact-absorbing mechanism of claim 1, wherein:
with the biasing member in the rest position, the impact-absorbing mechanism operates as a rigid joint, and
with the biasing member in the loaded position, the impact-absorbing mechanism operates as a resilient joint.

5. The impact-absorbing mechanism of claim 2, wherein the axis is a first axis, and the connection assembly is a pivoting connection assembly configured to pivot about one of the first axis and a second axis angled relative to the first axis.

6. The impact-absorbing mechanism of claim 1, wherein the biasing member is a resilient member made from a resilient material.

7. The impact-absorbing mechanism of claim 6, wherein the resilient material is an elastomeric material.

8. The impact-absorbing mechanism of claim 6, wherein the resilient material is a plurality of resilient materials, each resilient material of the plurality of resilient material having a given rigidity for providing a composite shock absorption profile.

9. The impact-absorbing mechanism of claim 1, wherein the biasing member is at least one of a spring member, a pneumatic member, and a hydraulic member.

10. The impact-absorbing mechanism of claim 1, wherein the biasing member is a frangible biasing member configured to break in response to the force applied along the second direction being greater than a pre-determined magnitude.

11. The impact-absorbing mechanism of claim 10, wherein the biasing member is selectively removable from the biasing assembly for replacement.

12. The impact-absorbing mechanism of claim 1, wherein the first and second components move relative to one another along a translational movement or a pivotal movement.

13. The impact-absorbing mechanism of claim 1, wherein at least one of the first and second components is an integral component of at least one of the structure and the vehicle.

14. The impact-absorbing mechanism of claim 1, wherein the structure is a bumper.

15. The impact-absorbing mechanism of claim 14, wherein the bumper is a rigid bumper.

16. The impact-absorbing mechanism of claim 14, wherein:
the bumper is a flexible bumper comprising a first sub-structure and a second sub-structure, and an other mechanism, and
the mechanism is for attaching the first sub-structure to the vehicle, and the second mechanism is for attaching the first sub-structure to the second sub-structure.

17. The impact-absorbing mechanism of claim 1, wherein the structure is at least one of: a rock slider, a push frame, a tail tongue, and a fender protector.

18. An impact-absorbing mechanism assembly comprising:
a first mechanism according to claim 1, and
a second mechanism according to claim 1;
the first mechanism and the second mechanism being connected in one of: series or parallel for forming a composite shock absorption profile.

19. A mounting system for mounting the structure to the vehicle, the mounting structure comprising one or more impact-absorbing mechanisms of claim 1.

20. A structure connectable to the vehicle or to another structure selectively fixedly connected to the vehicle using the mounting system of claim 19.
